(19) United States
(12) Patent Application Publication
(10) Pub. No.: US 2022/0222491 A1
(43) Pub. Date: Jul. 14, 2022

(54) SYSTEM AND METHOD FOR LIGHTWEIGHT SEMANTIC MASKING

(71) Applicant: Samsung Electronics Co., Ltd., Suwon-si (KR)

(72) Inventors: JongHo Shin, Santa Clara, CA (US); Larry P. Heck, Atlanta, GA (US)

(21) Appl. No.: 17/396,510

(22) Filed: Aug. 6, 2021

Related U.S. Application Data
(60) Provisional application No. 63/136,619, filed on Jan. 12, 2021.

(51) Int. Cl. G06K 9/62; G06F 40/30; G06N 3/04; G06F 40/40

(52) U.S. Cl. CPC G06K 9/6262; G06F 40/40; G06N 3/0454; G06F 40/30

(57) ABSTRACT

A method includes performing, using at least one processor of an electronic device, semantic probing on a pre-trained model using one or more textual utterances. Performing the semantic probing includes processing each of the one or more textual utterances to determine a performance score for one or more targeted hidden layers of the pre-trained model. Performing the semantic probing also includes selecting a subset of the targeted hidden layers based on a comparison of the performance score to a predetermined threshold. The method also includes reconstructing, using the at least one processor, the pre-trained model based on the semantic probing to generate a reconstructed model.

### CROSS-REFERENCE TO RELATED APPLICATION AND PRIORITY CLAIM

This application claims priority under 35 U.S.C. § 119(e) to U.S. Provisional Patent Application No. 63/136,619 filed on Jan. 12, 2021, which is hereby incorporated by reference in its entirety.

### TECHNICAL FIELD

This disclosure relates generally to machine learning systems. More specifically, this disclosure relates to a system and method for lightweight semantic masking.

### BACKGROUND

Data-driven natural language processing is prevalent in many commercialized services, such as voice-based searches and virtual assistants. Some conventional natural language processing techniques use a transformer-based language model for various language understanding tasks. However, these types of models often present various drawbacks in commercialization. Typically, these types of models are very large and require significant computing power in training and significant storage for parameters. These types of models can be especially impractical for on-device training and inferencing in Internet-of-Things (IoT) devices and mobile devices because of the limited resources and long training times in such devices.

### SUMMARY

This disclosure provides a system and method for lightweight semantic masking.

In a first embodiment, a method includes performing, using at least one processor of an electronic device, semantic probing on a pre-trained model using one or more textual utterances. Performing the semantic probing includes processing each of the one or more textual utterances to determine a performance score for one or more targeted hidden layers of the pre-trained model. Performing the semantic probing also includes selecting a subset of the targeted hidden layers based on a comparison of the performance score to a predetermined threshold. The method also includes reconstructing, using the at least one processor, the pre-trained model based on the semantic probing to generate a reconstructed model.

In a second embodiment, an electronic device includes at least one memory configured to store instructions. The electronic device also includes at least one processing device configured when executing the instructions to perform semantic probing on a pre-trained model using one or more textual utterances. To perform the semantic probing, the at least one processing device is configured when executing the instructions to process each of the one or more textual utterances to generate a performance score for one or more targeted hidden layers of the pre-trained model. To perform the semantic probing, the at least one processing device is also configured when executing the instructions to select a subset of the targeted hidden layers based on a comparison of the performance score to a predetermined threshold. The at least one processing device is also configured when executing the instructions to reconstruct the pre-trained model based on the semantic probing to generate a reconstructed model.

In a third embodiment, a non-transitory machine-readable medium contains instructions that when executed cause at least one processor of an electronic device to perform semantic probing on a pre-trained model using one or more textual utterances. The instructions that when executed cause the at least one processor to perform the semantic probing include instructions that when executed cause the at least one processor to process each of the one or more textual utterances to generate a performance score for one or more targeted hidden layers of the pre-trained model. The instructions that when executed cause the at least one processor to perform the semantic probing also include instructions that when executed cause the at least one processor to select a subset of the targeted hidden layers based on a comparison of the performance score to a predetermined threshold. The medium also contains instructions that when executed cause the at least one processor to reconstruct the pre-trained model based on the semantic probing to generate a reconstructed model.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example process for lightweight semantic masking according to this disclosure;

FIGS. 3A and 3B illustrate an example semantic probing process for use in the lightweight semantic masking process of FIG. 2 according to this disclosure;

FIG. 4 illustrates an example binary masking process for use in the lightweight semantic masking process of FIG. 2 according to this disclosure; and

FIG. 5 illustrates an example method for lightweight semantic masking according to this disclosure.

### DETAILED DESCRIPTION

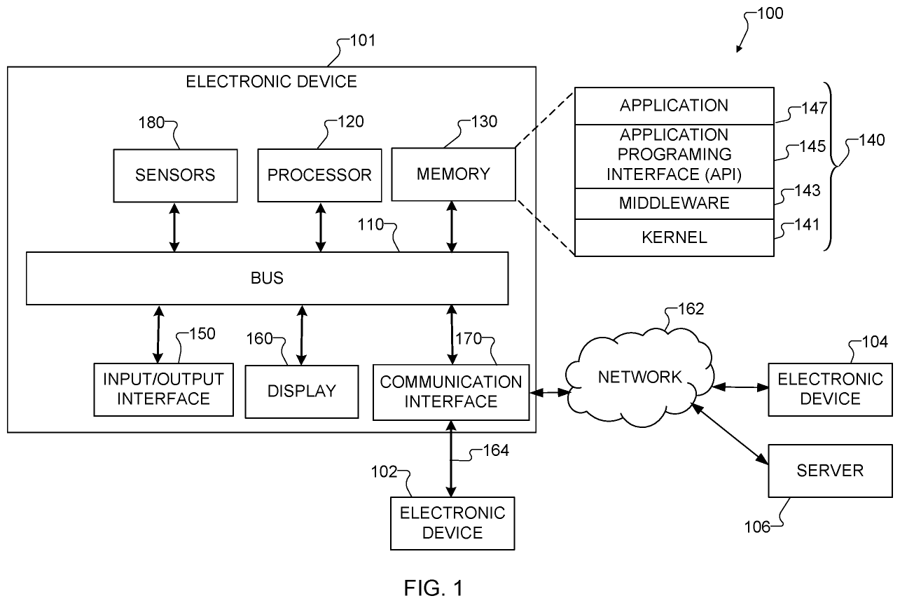

FIGS. 1 through 5, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As noted above, data-driven natural language processing is prevalent in many commercialized services, such as voice-based searches and virtual assistants. Some conventional natural language processing techniques use a transformer-based language model (such as Bidirectional Encoder Representations from Transformers or “BERT”) for various language understanding tasks. Some of these models are pre-trained with multi-task objectives, such as masked language modeling and next-sentence prediction, and may use billions of English words. However, these types of models often present various drawbacks in commercialization. Typically, these types of models are very large and require significant computing power in training and significant storage for parameters. These types of models can be especially impractical for on-device training and inferencing in Internet-of-Things (IoT) devices and mobile devices because of the limited resources and long training times in such devices. For example, even simple task training with small amounts of data can take hours because the training may update a very large number of parameters (such as millions, hundreds of millions, or even more parameters) of a pre-trained model with fine-tuning.

This disclosure provides systems and methods for lightweight semantic masking, which perform semantic probing on a pre-trained model using textual utterances. The semantic probing is performed to reduce the size of the model and reduce training time while still achieving most of the performance of conventional training. The disclosed systems and methods also generate a parameter-reducing binary mask (such as a 2-bit representation instead of a 32-bit floating-point representation) for a task using a reconstructed model based on the pre-trained model. This further reduces the size of the model and substantially reduces the time needed for training. Applying the binary mask enables efficient and effective usage of space and processing power for handling multiple language understanding tasks. The resulting model can be significantly smaller (such as up to 90% smaller or more) while still maintaining performance that is equal to, or nearly equal to, the performance of a much larger model. The resulting model can be incorporated into a variety of devices, such as consumer electronic devices like smartphones, smart watches, refrigerators, washers, dryers, cleaning robots, and the like. Note that while some of the embodiments discussed below are described in the context of neural networks, this is merely one example, and it will be understood that the principles of this disclosure may be implemented in any number of other suitable contexts.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor 120 can be a graphics processor unit (GPU). As described in more detail below, the processor 120 may perform one or more operations for lightweight semantic masking.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for lightweight semantic masking as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HIVID). When the electronic device 101 is mounted in the electronic device 102 (such as the HIVID), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support lightweight semantic masking.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

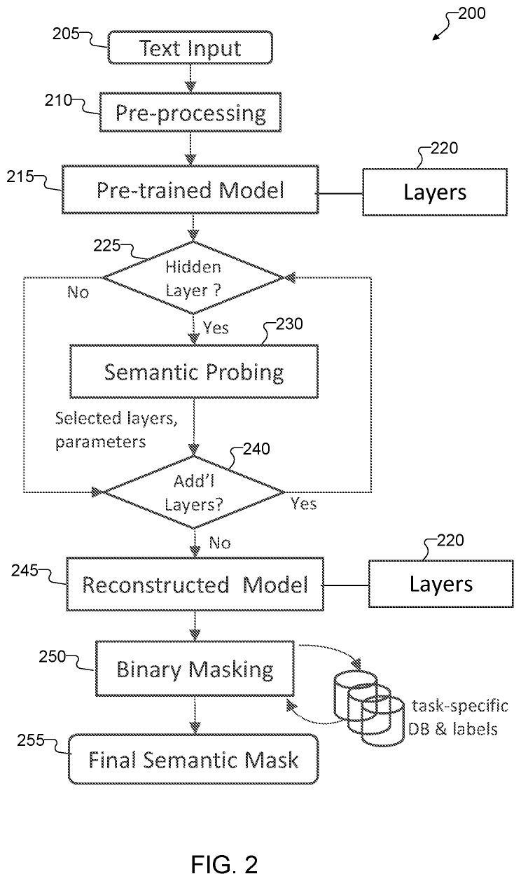

FIG. 2 illustrates an example process 200 for lightweight semantic masking according to this disclosure. In some embodiments, the process 200 can be performed to reduce the number of parameters of a machine learning model used for training and inferencing, which is accomplished by use of semantic information and binary masking. For ease of explanation, the process 200 is described as being performed by the electronic device 101 shown in FIG. 1. However, the process 200 could be performed using any other suitable electronic device (such as the server 106 of FIG. 1) and in any other suitable system.

As shown in FIG. 2, in the process 200, the electronic device 101 receives a text input 205. The text input 205 represents a textual sentence, question, or other text-based input for use in a classification task. An example text input 205 could be “Where is an Italian restaurant?” In some embodiments, the text input 205 is one of hundreds or thousands of inputs that may be used as training data. Note that, in some cases, the text-based input 205 may represent a spoken or other verbal or audio input that is converted into text.

The electronic device 101 performs one or more pre-processing operations 210 on the text input 205. The pre-processing operations 210 represent any suitable text processing operations, such as tokenizing or removing unnecessary characters (like parentheses, semicolons, and the like) from the text input 205. The pre-processing operations 210 modify the text input 205 to be suitable for use as an input to a pre-trained model 215.

The pre-trained model 215 is a machine learning model used for natural language processing. In some embodiments, the pre-trained model 215 is a transformer-based contextual representation model. Also, in some embodiments, the pre-trained model 215 is a commercially-available model, such as a BERT model. In other embodiments, the pre-trained model 215 can be built or generated internally. For example, the pre-trained model 215 can be built using millions (or more) of utterances obtained from one or more users using a virtual assistant over time. The pre-trained model 215 can also be built using text obtained from different sources, such as WIKIPEDIA.COM or other online sources.

The pre-trained model 215 includes multiple layers 220, which include multiple hidden layers like transformer layers. Each hidden layer is an encoder that outputs one or more vectors having a certain length. The hidden layers are connected in that the output of layer n (or a processed version of the output of layer n) is the input for layer n+1. Therefore, it can be determined whether a layer 220 is a hidden layer by checking its inputs and outputs. For example, in the BERT model, the inputs to an embedding layer (which is not a hidden layer) are tokens, and the outputs of the embedding layer are embeddings. Thus, if a particular layer 220 is identified as including tokens and/or embeddings, it can be determined that the layer 220 is not a hidden layer. In some embodiments, a list of hidden layers can be obtained from specification or reference information provided with the pre-trained model 215.

The electronic device 101 performs a layer-by-layer examination of the layers 220 in the pre-trained model 215. At operation 225, the electronic device 101 determines whether or not a particular layer 220 is a hidden layer, such as by examining layer inputs and layer outputs (as discussed above), by reviewing specification or reference information provided with the pre-trained model 215, or by using any other suitable technique for examining a layer of the pre-trained model 215. If the electronic device 101 determines that a particular layer 220 is not a hidden layer, the electronic device 101 determines if there are any more layers 220 in the pre-trained model 215 to examine as shown at operation 240. If the electronic device 101 determines that a particular layer 220 is a hidden layer, the electronic device 101 performs a semantic probing process 230 on the layer 220. In the semantic probing process 230, the electronic device 101 trains multiple contextual vectors, predicts semantic information, and determines whether or not to keep a particular layer 220 based on the layer's performance of semantic inference as discussed in greater detail below.

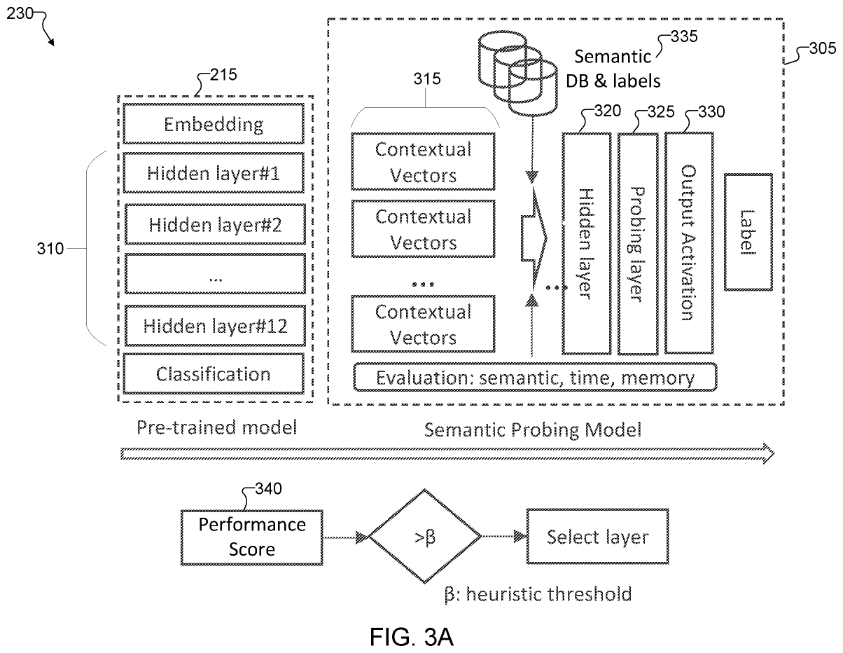

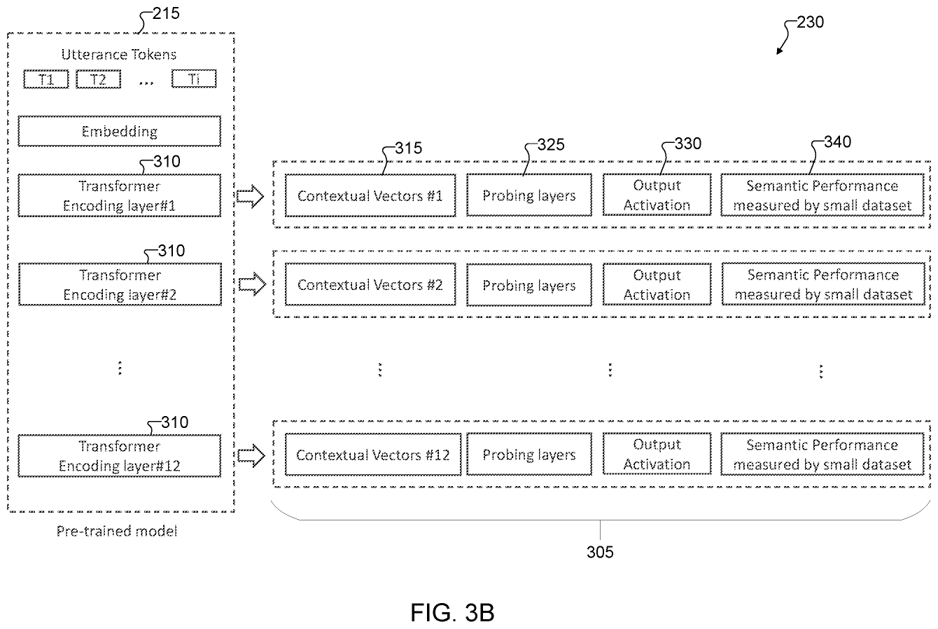

FIGS. 3A and 3B illustrate an example semantic probing process 230 for use in the lightweight semantic masking process 200 of FIG. 2 according to this disclosure. As shown in FIGS. 3A and 3B, in the semantic probing process 230, the electronic device 101 generates multiple semantic probing models 305 based on the pre-trained model 215. In the example shown, the pre-trained model 215 includes twelve hidden layers 310, which are a subset of the layers 220. In some embodiments, the pre-trained model 215 is a transformer-based contextualized representation model, and the hidden layers 310 are transformer encoding layers. Of course, this is merely one example, and other pre-trained models 215 could include other numbers and types of hidden layers 310.

In the semantic probing process 230, the electronic device 101 targets the hidden layers 310 and generates an equal number (such as twelve) of small semantic probing models 305 to extract a set of contextual vectors 315 from the hidden layers 310. For each semantic probing model 305, the electronic device 101 builds one or more hidden layers 320, one or more probing layers 325 (such as fully-connected layers), and one or more output activation layers 330 on top of the corresponding set of contextual vectors 315. In some embodiments, the hidden layers 320 (such as multi-layer perceptron (MLP) layers) are optional and can be used to boost performance depending on resources and time constraints. The electronic device 101 obtains training data from a semantic database 335, which contains textual utterances and semantic labels that are not part of the main training data (such as the text inputs 205) and are used for creating the semantic probing models 305. For example, for a semantic label “Temperature,” a corresponding training utterance “Set the temperature to 69 degrees in the bedroom” can be used. This utterance may later be used for the classification task on the place, such as “room.”

The electronic device 101 trains each contextual vector 315 on the semantic probing model 305, and the semantic probing model 305 predicts how much semantic information is present. As discussed below, the electronic device 101 determines whether or not to keep the hidden layer 310 based on the prediction performance of the semantic inference by the semantic probing model 305. The contextualized representation of each hidden layer 310 differs in the semantic meaning and relationships between words as learned from co-occurrence statistics on unlabeled data. In the semantic probing process 230, the electronic device 101 probes word-level contextual representations from the extracted contextual vectors 315.

In predicting semantic information, the semantic probing model 305 measures how well semantic meanings can be extracted from the hidden layers 310 of the pre-trained model 215. For example, the semantic probing model 305 can process the word-level contextual representations and determine how the contextual representations encode semantic information across words of sentences in long-range phenomena. The word-level contextual representations can be processed by encoding words using the hidden layers 310 of the pre-trained model 215 and reviewing the output of each hidden layer 310. In some embodiments, the sematic meaning is labeled in the training data, and the performance can be measured as discussed below. Also, in some embodiments, the word-level contextual representations can be constructed by an attention mechanism in each hidden layer 310. Of course, other suitable methods for constructing the word-level contextual representations are within the scope of this disclosure.

One objective of the semantic probing model 305 can include reducing or minimizing training time for training each hidden layer 310. The training time and the size of the semantic probing model 305 can be reduced by using small training datasets (such as 300 training utterances and 60 validation utterances or other small datasets). Using a small training dataset, the semantic probing model 305 is trained by minimizing an objective function against the target semantic label. In some embodiments, the objective function is a binary cross-entropy loss function for a semantic label classification, and the training is ended by the accuracy saturated epoch. Of course, this is merely one example, and other objective functions can be used.

As discussed above, the semantic probing model 305 can train until the semantic accuracy performance is saturated. However, in some circumstances, the semantic probing model 305 can stop training early (such as before saturation). For example, the semantic probing model 305 may stop training early if there is a time limit, such as “training should finish in N seconds.” As another example, the semantic probing model 305 may train on only a subset of contextual vectors 315 (such as the first K contextual vectors 315) if there is limited memory. In general, there is a trade-off between performance and time or resources. That is, limiting the training time or number of trained contextual vectors 315 results in faster operation but tends to lower the performance of the semantic probing model 305.

After prediction by the semantic probing model 305, the electronic device 101 determines a prediction performance score 340 for the semantic probing model 305. In some embodiments, the prediction performance score 340 is based on the accuracy of predictions or other suitable metric. Later, the electronic device 101 compares the prediction performance score 340 of the semantic probing model 305 to a threshold value β, which can be determined by heuristics, according to business requirements, or in any other suitable manner. If the prediction performance score 340 of the semantic probing model 305 is greater than the threshold value β, the hidden layer 215 corresponding to the semantic probing model 305 is selected.

Turning again to FIG. 2, the electronic device 101 determines if there are any more layers 220 in the pre-trained model 215 to examine at operation 240. If there are additional layers, the electronic device 101 moves to the next layer 220 and performs the operation 225 and the semantic probing process 230 for that layer. For each hidden layer 310, the electronic device 101 either selects or does not select the hidden layer 310 based on the results of the semantic probing process 230 for that layer. Following examination of all of the hidden layers 215, a selected subset of the hidden layers 215 exists. Once there are no more layers 220 to examine, the electronic device 101 reconstructs the pre-trained model 215 to generates a reconstructed model 245.

To generate the reconstructed model 245, the electronic device 101 copies the pre-trained model 215 except for the hidden layers 310 that are re-processed by the semantic probing process 230, and the electronic device 101 adds the selected subset of hidden layers 310 and corresponding parameters to the copied pre-trained model 215. In some embodiments, the selected subset includes both one or more original hidden layers 310 and one or more updated hidden layers 310. In some embodiments, it is possible that the semantic probing process 230 does not disregard any hidden layer 310 or modify any parameter. In that case, the reconstructed model 245 will be copied with all layers 220 of the pre-trained model 215. After the electronic device 101 has generated the reconstructed model 245, the electronic device 101 performs a binary masking process 250 on the reconstructed model 245 to determine a final semantic mask 255. The binary masking process 250 is performed to select a subset of parameters that are important to one or more specific tasks of the reconstructed model 245 and discard unimportant parameters using binarization.

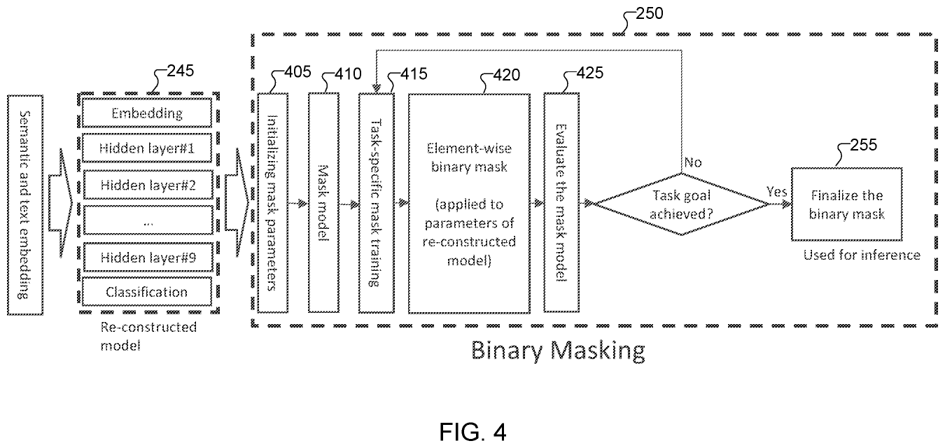

FIG. 4 illustrates an example binary masking process 250 for use in the lightweight semantic masking process 200 of FIG. 2 according to this disclosure. In some embodiments, the binary masking process 250 may be performed for a specific task of interest. As shown in FIG. 4, with reference to the reconstructed model 245, the electronic device 101 initializes multiple mask parameters 405 in a mask model 410 and associates the mask model 410 with the layers 220 of the reconstructed model 245. The mask parameters 405 are initialized with real floating-point (non-binary) trainable numbers that are selected randomly, such as 32-bit floating point values. In some cases, the quantity of mask parameters 405 in the mask model 410 is the same as the quantity of parameters of the reconstructed model 245.

The electronic device 101 performs training 415 of the mask model 410 for a specific task, such as a task with concatenated semantic and text embedding. For example, one natural language processing task (“entity recognition”) is a typical task for training the mask parameters 405, and the task goal is to achieve the highest performance. The task is what the mask parameters 405 are optimized for and binarized at the end of the binary masking process 250. After training for the specific task, the electronic device 101 determines the real number mask weights and produces a binary mask 420 in which the mask parameters 405 are updated with an element-wise parameter thresholding function K, such as K={1 if parameter value>threshold value, 0 otherwise}. Here, the threshold value is a real number between 0 and 1 (such as 0.50). In some embodiments, the threshold value is determined heuristically. Thus, after the thresholding function, each mask parameter 405 has a value of 0 or 1.

Using the determined binary mask 420, the electronic device 101 multiplies the parameters of the reconstructed model 245 by the mask parameters 405 in an element-wise binarization computation to generate masked parameters. Each masked parameter of the reconstructed model 245 is either retained or discarded. For example, if the value of the mask parameter 405 in the binary mask 420 is 0, the corresponding masked parameter of the reconstructed model 245 is discarded. If the value of the mask parameter 405 in the binary mask 420 is 1, the corresponding masked parameter of the reconstructed model 245 is retained for use during training and inferencing. Thus, the binarization is performed to filter out less meaningful parameters.

After binarization is completed, the electronic device 101 performs an evaluation operation 425 on the masked parameters to determine if the task goal has been achieved. In some embodiments, the task goal includes accuracy for classification, root mean square error for regression problems, and the like. If the task goal has not been achieved, the electronic device 101 performs another iteration of mask training 415. In each iteration of the mask training 415, the electronic device 101 acquires updated weights from the reconstructed model 245 using a product of the binary mask and the pretrained weights and updates the binary mask 420. In some embodiments, the number of iterations performed can be up to the number of epochs for training. Also, in some embodiments, the electronic device 101 terminates training once accuracy saturation is reached. After the electronic device 101 concludes the iterations of mask training 415, the electronic device 101 stores the finalized binary mask as the final semantic mask 255, which (ideally) uses substantially less memory than a conventional model. For example, in some cases, the final semantic mask 255 may have only about 3% of the memory required for a conventional model that saves 32-bit floating point parameters.

Note that the operations and functions shown in FIGS. 2 through 4 can be implemented in an electronic device 101, server 106, or other device in any suitable manner. For example, in some embodiments, these operations and functions can be implemented or supported using one or more software applications or other software instructions that are executed by the processor 120 of the electronic device 101, server 106, or other device. In other embodiments, at least some of these operations and functions can be implemented or supported using dedicated hardware components. In general, these operations and functions can be performed using any suitable hardware or any suitable combination of hardware and software/firmware instructions.

Although FIGS. 2 through 4 illustrate one example of a process 200 for lightweight semantic masking and related details, various changes may be made to FIGS. 2 through 4. For example, while shown as a specific sequence of operations, various operations shown in FIGS. 2 through 4 could overlap, occur in parallel, occur in a different order, or occur any number of times (including zero times). Also, the specific operations shown in FIGS. 2 through 4 are examples only, and other techniques could be used to perform each of the operations shown in FIGS. 2 through 4.

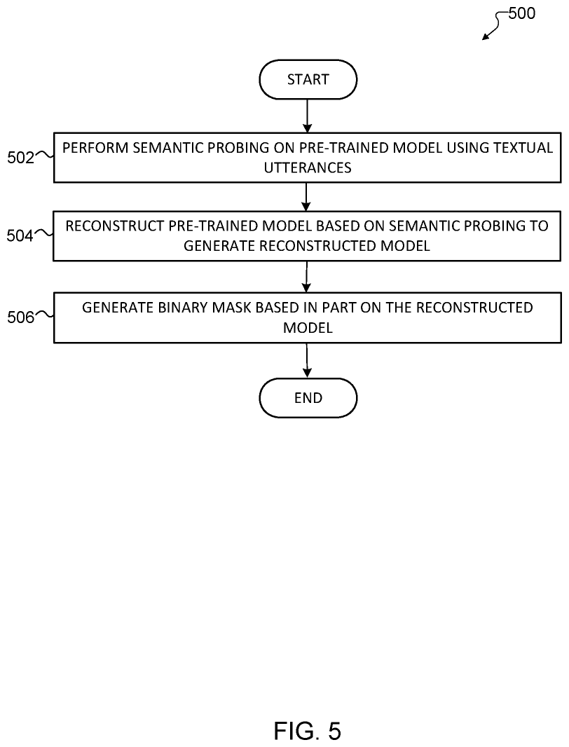

FIG. 5 illustrates an example method 500 for lightweight semantic masking according to this disclosure. For ease of explanation, the method 500 shown in FIG. 5 is described as involving the use of the process 200 shown in FIGS. 2 through 4 and the electronic device 101 shown in FIG. 1. However, the method 500 shown in FIG. 5 could be used with any other suitable electronic device (such as the server 106 of FIG. 1) and in any other suitable system.

As shown in FIG. 5, semantic probing is performed on a pre-trained model using one or more textual utterances at step 502. This could include, for example, the electronic device 101 performing the semantic probing process 230 on a pre-trained model 215 using one or more textual utterances from the semantic database 335. The pre-trained model is reconstructed based on the semantic probing to generate a reconstructed model at step 504. This could include, for example, the electronic device 101 reconstructing the pre-trained model 215 based on the semantic probing process 230 to generate a reconstructed model 245.

A binary mask is generated based (at least in part) on the reconstructed model at step 506. This could include, for example, the electronic device 101 generating and training a binary mask 420 using the binary masking process 250, which is based (at least in part) on the reconstructed model 245. The binary mask 420 can be stored and used as a final semantic mask 255. In some embodiments, the binary mask can be generated for a specific task with semantic and text embedding.

Although FIG. 5 illustrates one example of a method 500 for lightweight semantic masking, various changes may be made to FIG. 5. For example, while shown as a series of steps, various steps in FIG. 5 could overlap, occur in parallel, occur in a different order, or occur any number of times.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
performing, using at least one processor of an electronic device, semantic probing on a pre-trained model using one or more textual utterances, wherein performing the semantic probing comprises:
processing each of the one or more textual utterances to determine a performance score for one or more targeted hidden layers of the pre-trained model; and
selecting a subset of the targeted hidden layers based on a comparison of the performance score to a predetermined threshold; and
reconstructing, using the at least one processor, the pre-trained model based on the semantic probing to generate a reconstructed model.

2. The method of claim 1, wherein the reconstructed model is generated based on the selected subset of targeted hidden layers.

3. The method of claim 1, wherein:
the selected subset of targeted hidden layers comprises one or more original targeted hidden layers and one or more updated hidden layers; and
the reconstructed model is generated using the one or more original targeted hidden layers and the one or more updated hidden layers.

4. The method of claim 1, wherein the pre-trained model comprises a contextualized representation model.

5. The method of claim 1, further comprising:
generating, using the at least one processor, a binary mask based on the reconstructed model, the binary mask generated for a specific task with semantic and text embedding.

6. The method of claim 5, wherein generating the binary mask further comprises:
generating an initial binary mask based on a threshold of real number mask weights for the specific task;
applying the initial binary mask on multiple parameters of the reconstructed model to generate masked parameters; and
evaluating the masked parameters to determine whether a goal of the specific task is met.

7. The method of claim 6, further comprising:
updating the binary mask in response to determining that the goal of the specific task is not met.

8. An electronic device comprising:
at least one memory configured to store instructions; and
at least one processing device configured when executing the instructions to:
perform semantic probing on a pre-trained model using one or more textual utterances, wherein, to perform the semantic probing, the at least one processing device is configured when executing the instructions to:
process each of the one or more textual utterances to generate a performance score for one or more targeted hidden layers of the pre-trained model; and
select a subset of the targeted hidden layers based on a comparison of the performance score to a predetermined threshold; and
reconstruct the pre-trained model based on the semantic probing to generate a reconstructed model.

9. The electronic device of claim 8, wherein the at least one processing device is configured when executing the instructions to generate the reconstructed model based on the selected subset of targeted hidden layers.

10. The electronic device of claim 8, wherein:
the selected subset of targeted hidden layers comprises one or more original targeted hidden layers and one or more updated hidden layers; and
the at least one processing device is configured when executing the instructions to generate the reconstructed model using the one or more original targeted hidden layers and the one or more updated hidden layers.

11. The electronic device of claim 8, wherein the pre-trained model comprises a contextualized representation model.

12. The electronic device of claim 8, wherein the at least one processing device is further configured when executing the instructions to generate a binary mask based on the reconstructed model for a specific task with semantic and text embedding.

13. The electronic device of claim 12, wherein to generate the binary mask, the at least one processing device is configured when executing the instructions to:
generate an initial binary mask based on a threshold of real number mask weights for the specific task;
apply the initial binary mask on multiple parameters of the reconstructed model to generate masked parameters; and
evaluate the masked parameters to determine whether a goal of the specific task is met.

14. The electronic device of claim 13, wherein the at least one processing device is further configured when executing the instructions to update the binary mask in response to determining that the goal of the specific task is not met.

15. A non-transitory machine-readable medium containing instructions that when executed cause at least one processor of an electronic device to:
perform semantic probing on a pre-trained model using one or more textual utterances, wherein the instructions that when executed cause the at least one processor to perform the semantic probing comprise instructions that when executed cause the at least one processor to:
process each of the one or more textual utterances to generate a performance score for one or more targeted hidden layers of the pre-trained model; and
select a subset of the targeted hidden layers based on a comparison of the performance score to a predetermined threshold; and
reconstruct the pre-trained model based on the semantic probing to generate a reconstructed model.

16. The non-transitory machine-readable medium of claim 15, wherein the instructions when executed cause the at least one processor to generate the reconstructed model based on the selected subset of targeted hidden layers.

17. The non-transitory machine-readable medium of claim 15, wherein:
the selected subset of targeted hidden layers comprises one or more original targeted hidden layers and one or more updated hidden layers; and
the instructions when executed cause the at least one processor to generate the reconstructed model using the one or more original targeted hidden layers and the one or more updated hidden layers.

18. The non-transitory machine-readable medium of claim 15, wherein the pre-trained model comprises a contextualized representation model.

19. The non-transitory machine-readable medium of claim 15, wherein the instructions when executed further cause the at least one processor to generate a binary mask based on the reconstructed model for a specific task with semantic and text embedding.

20. The electronic device of claim 15, wherein the instructions that when executed cause the at least one processor to generate the binary mask comprise instructions that when executed cause the at least one processor to:
generate an initial binary mask based on a threshold of real number mask weights for the specific task;
apply the initial binary mask on multiple parameters of the reconstructed model to generate masked parameters; and
evaluate the masked parameters to determine whether a goal of the specific task is met.
